(19) United States
(12) Patent Application Publication
(10) Pub. No.: US 2002/0078525 A1
(43) Pub. Date: Jun. 27, 2002

(54) Hinge mechanism with a plurality of hinges

(75) Inventors: Fang Hua, Hamilton (CA); Vincente P. Nunes, Mississauga (CA)

Correspondence Address: John E. Beck, Xerox Corporation, Xerox Square - 20A, Rochester, NY, 14644, US

(73) Assignee: Xerox Corporation

(21) Appl. No.: 09/746,868

(22) Filed: Dec. 21, 2000

(51) Int. Cl. E05D 1/00

(52) U.S. Cl. 16/221

(57) ABSTRACT

An improved hinge assembly and related process using a plurality of hinge elements for mounting a door to an enclosure body. The hinge assembly comprises a first hinge; a second hinge; and a hinge body having a first and second edge wherein the first hinge is connected to the hinge body proximate to the first edge and the second hinge is connected to the hinge body proximate to the second edge and wherein a single force operating upon the door sequentially moves the first hinge and then the second hinge. A preferred embodiment is to make the hinge and hinge body out of a single piece of semi-rigid material such as a plastic and to configure the hinge assembly such that the door rests tightly against the enclosure body when the hinges are in their closed position.

### BACKGROUND OF THE INVENTION

The field of the proposed invention relates to cabinet hinge devices and in particular to an inexpensive double hinge mechanism designed to enable a cabinet door to fit tightly to a cabinet housing and to open with a first separation movement followed by a door opening movement.

Double hinge mechanisms, especially for door closure applications have been well known for over a century. A common application of such double hinge devices is for so-called “swinging doors” wherein the double hinge allows a door to swing through the doorjamb in either direction. As shown in U.S. Pat. No. 5,482,067, issued to Wittrock et al., the same type of double hinge can be utilized allow both halves of a suitcase-type container to open in a flat fully open position. Another use of a double hinge device is disclosed in U.S. Pat. No. 4,535,908, issued to Dabich, wherein a double hinge assembly enables sequential opening of a compound hatchway. In particular, Dabich discloses a first hinge that enables an outer cover to be lifted, thereby providing leverage for lifting of an inner cover connected at a second hinge. Yet another use of a double hinge assembly is disclosed in U.S. Pat. No. 5,953,860, issued to Morgan et al., where a double hinge is used for first moving a door laterally inside a pocket formed in one of the jambs and then, once moved laterally, for secondly swinging the door open and out of the door pocket.

In each of the double hinge arrangements discussed above, the two hinges are connected by a rigid straight member. Also, when the system is designed for sequential operation of the hinges, the order in which the hinges open is determined by varying the direction of forces that operate upon the hinges. Lastly, each of the double hinge arrangements discussed above is relatively expensive and bulky since each hinge typically comprises its own mounting flanges, internal springs, cylindrical spring housing, and other elements designed to structurally hold each hinge together while allowing desired movement around a pivot point (which typically is formed of a solid rod member).

Cabinetry for much modern home, office, and industrial equipment is formed of sheet metal or plastic. For many reasons, it is desirable that door or cover members fit snugly to the cabinet or housing in which the equipment resides. Among the reasons that a snug fit is desirable are: appearance, minimization of dust inside the cabinet, minimization of light transmission into or out of the cabinet, sound proofing or safety-related isolation of the materials or equipment inside the cabinet, etc. Where appearance permits, mounting a simple hinge mechanism on the outside of the door and cabinet housing enables the door to rest snugly against the cabinet when closed. As the door is opened, the door can freely pivot away from the cabinet upon the hinge. For hinges that must be mounted internally to the enclosure, however, a door that is snugly fit against the cabinet face must first be lifted away from the face surface in order to obtain clearance of its corner when it pivots around the hinge. In typical cabinets, including cabinets used for kitchen shelving, etc, small gaps are permitted between the cabinet housing and the edge of the door proximate to the hinge. Several hinge arrangements are known which enable cabinet doors to rest snugly against the housing without any gap proximate to the hinge. However, such hinge arrangements require a number of different parts and relatively precise alignment and positioning.

It would be advantageous to have an inexpensive hinge arrangement mounted inside a cabinet housing or other enclosure body (including, without limitation, a building) wherein the hinge enables a door (including, without limitation, any hinged member such as windows, seals, shutters, etc.) to rest tightly against the enclosure housing. It would be further advantageous if such hinge comprised a single molded or extruded part which is easy to position and to attach during assembly operations.

### SUMMARY OF THE INVENTION

One aspect of the present invention is an improved hinge assembly with a plurality of hinge elements for mounting a door to an enclosure body, comprising: a first hinge; a second hinge; and a hinge body having a first and second edge wherein the first hinge is connected to the hinge body proximate to the first edge and the second hinge is connected to the hinge body proximate to the second edge and wherein a single force operating upon the door sequentially moves the first hinge and then the second hinge.

A second aspect of the present invention is a process for opening a door covering of an enclosure body wherein the door covering is attached to the enclosure body by a plurality of hinge elements connected by a hinge body, said process comprising: applying an opening force to the door wherein the force first operates upon a first hinge element; continuing application of the force until the first hinge element has mostly opened; and continuing application of the force until the force operates primarily upon a second hinge element after the first hinge element has mostly opened.

### BRIEF DESCRIPTION OF THE DRAWINGS

Other aspects of the present invention will become apparent as the following description proceeds and upon reference to the drawings, in which:

FIG. 1 is an elevational cross-sectional view of the double hinge apparatus of the present invention in its closed configuration;

FIG. 2 is an elevational cross-sectional view of the double hinge apparatus of the present invention after its first hinge movement has opened;

FIG. 3 is an elevational cross-sectional view of the double hinge apparatus of the present invention in its fully open configuration;

FIG. 4 is a perspective view of the double hinge apparatus of the present invention in its pre-assembly, stand-alone configuration.

### DETAILED DESCRIPTION OF THE DRAWINGS

While the present invention will hereinafter be described in connection with its preferred embodiments and methods of use, it will be understood that it is not intended to limit the invention to these embodiments and methods of use. On the contrary, the following description is intended to cover all alternatives, modifications, and equivalents, as may be included within the spirit and scope of the invention as defined by the appended claims.

One aspect of the present invention is a double hinge apparatus wherein a single force intended to open a door closure operates to cause movement of a first hinge component followed thereafter by movement of the second hinge component. As will be explained below, a preferred embodiment of the present invention is an injection molded or extruded semi-rigid plastic double hinge apparatus in which both hinges and structural body elements of the hinge are formed in a single molding or extruding operation.

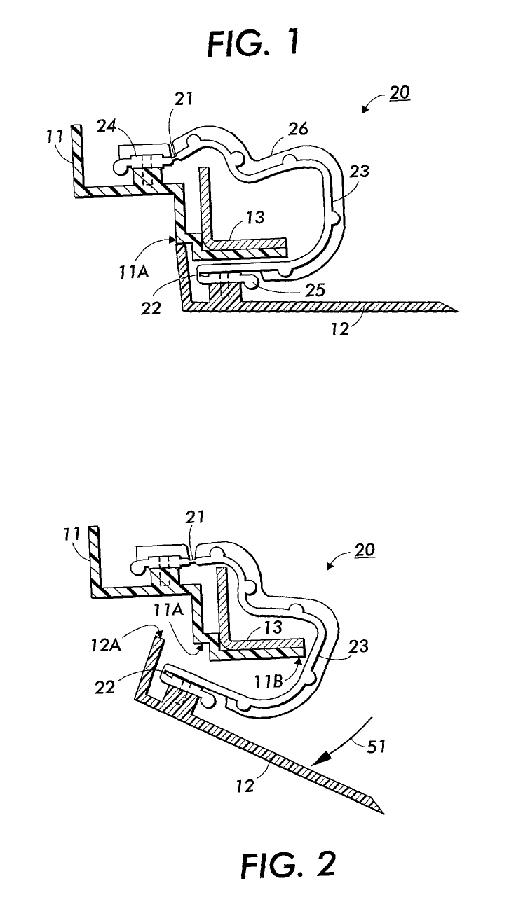

Turning to FIG. 1, the hinge 20 of the present invention is shown in an elevational cross-sectional view in its fully closed configuration. Cabinet housing 11 is shown as if formed from plastic or sheet metal. It should be understood that although cabinet housing 11 is shown with relatively thin walls, any thickness and material for forming the cabinet housing may work with the present invention. Door closure 12 is also shown as if formed of plastic or sheet metal and may in practice be formed in any thickness and of any material, specifically including wood. Stop 13 is shown fixedly attached to the inside of cabinet housing 11. Its role in conjunction with hinge 20 will be discussed below. Of particular note in FIG. 1 is the manner in which edge 12A of door 12 nests snugly and without a gap upon ledge 11A of housing 11.

Double hinge apparatus 20 is comprised of first hinge 21 and second hinge 22. As shown, hinges 21 and 22 are formed of thin sections of hinge body 23. Hinge body 23 itself is formed in a general U-shape. Hinge 21 connects body 23 to attachment flange 24 which, in turn, is used to attach double hinge apparatus 20 to housing 11. Similarly, hinge 22 connects body 23 to attachment flange 25 which, in turn, is used to attach double hinge apparatus 20 to door 12. Although the cross sectional views in FIGS. 1-3 and the perspective view in FIG. 4 do not indicate a length of the double hinge apparatus 20 of the present invention, such a hinge can be of any length that can be fit within the housing/door configuration. For heavy doors, a long hinge in a “piano-hinge” style is preferred. Reinforcement ring 26 will be described more fully below in relation to FIG. 4.

A preferred embodiment of double hinge mechanism 20 of the present invention is in the single-component configuration shown. This configuration can be either extruded or molded out of any of various plastic or similarly flexible materials. In a preferred embodiment, hinge mechanism 29 is made of a thermoplastic resin such as polypropylene. In principle, any polypropylene resin could be used. A suitable polypropylene resin with both sufficient flexibility and ability to carry a load is Hemont SM6100 with a density of 0.9 g/cm³ or Epsilon E-1112 with a density of 0.9 g/cm³. This resin has the additional desirable property of having a “memory”, i.e., when external forces are removed, the resin seeks to return to its originally formed shape. This “memory” imparts a spring-like effect and operates to either close or open the door whenever the operator releases the forces used to swing the door open. In this manner, the hinge itself comprises a spring. As explained above, the flexibility of body 23 and of hinges 21 and 22 can be adjusted simply by varying the thickness of double hinge apparatus 20 at any particular location. The strength of the spring action of each hinge is similarly dependent upon the amount of material used in the hinge and the strength of the memory of the resin used. In practice, the spring-like effect probably will not be sufficient to fully seal a door, and an auxiliary closure device such as a magnet may be required to fully close the door. Also, if the spring action is in the direction of opening the door, then a closure mechanism such as a magnet or snap fixture is desired.

Although hinge apparatus 20 is shown as a single extruded or molded part formed with double hinges integrated therein, the hinge of the present invention could be formed of multiple components, including without limitation, metal hinges and/or a metal hinge body. What is important for the present invention is that the hinges and hinge body are configured such that a single force applied to open the door operate upon the mechanism to sequentially open the hinges, thereby allowing a first hinge to swing the door away from the cabinet housing and a second hinge to then fully open the door. This operational characteristic is determined both by varying the “strength”, or resistance against movement, of the two hinges and by the curved shape of hinge body 23. In the configuration shown, a general u-shape is desired to conform to the housing/door configuration. For a different door/housing configuration, a different angled shape may be preferred, e.g. a j-shape, a more rounded shape, or a shape with straight sections and sharper angles.

Turning now to FIG. 2, hinge mechanism 20 of the present invention is shown after opening force 51 have been applied to cause movement of first hinge 21. It is preferable that the first hinge movement be limited to hinge 21 since the effect of its movement is to lift and free the edge 12A of door 12 from cabinet ledge 11A. After such lifting and freeing motion, then a gap is created between edge 12A of door 12 and housing 11 that will allow a more full range of motion to fully open the door. As indicated in FIG. 2, after a gap has been created between edge 12A and housing 11, both hinge 21 and hinge 22 are free to move. The design of hinge mechanism 20 can induce hinge 21 to move prior to hinge 22 in two basic manners: 1) build hinge 22 with more strength, or resistance to motion, than hinge 21, and/or 2) design hinge body 23 such that initial opening forces upon door 12 exert greater force upon hinge 21 than hinge 22. Regardless which method is chosen, it is preferable under the present invention for the range of motion of hinge 21 to be constricted after its movement has succeeded in freeing the edge of door 12 from contact with housing 11. As shown in FIG. 2, one method of accomplishing such constricted motion is insertion of a stop 13 that serves to arrest movement of body 23 after the first movement of hinge 21. In FIG. 2, stop 13 is actually a structural frame member that supports the weight of the cabinet and of housing 11 and door 12. In the particular configuration shown in FIGS. 1-3, it can be seen that even without stop 13, the movement of hinge 21 would be arrested by terminal point 11B of housing 11. Many other configurations of a stop like stop 13 are possible. As one of many possible examples, a rib feather could be added to housing 11 to achieve the same effect.

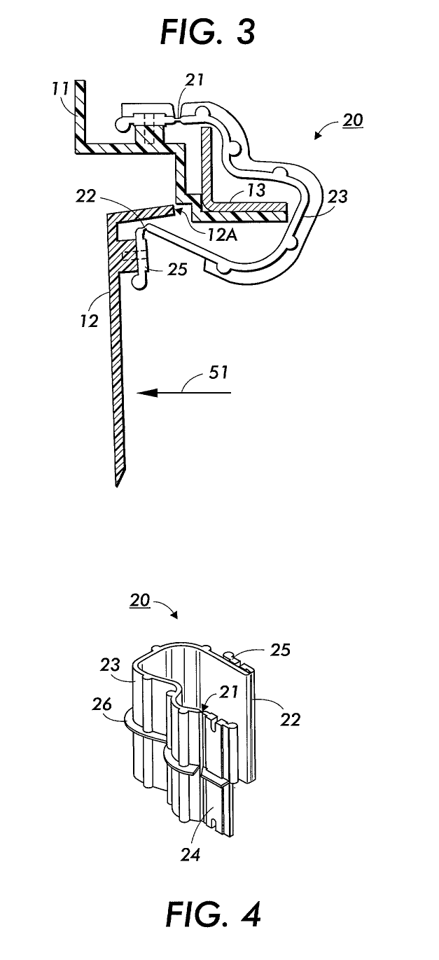

Turning now to FIG. 3, hinge mechanism 20 of the present invention is shown in its open position with door 12 swung 90 degrees from its closed position. As shown, it is clear that door 12 can be opened more than 90 degrees since its edge 12A is free of cabinet housing 11. Also clear from FIG. 3 is that hinge 22 has begun movement and that hinge 21 has fully opened through its entire range of motion. Thus, FIGS. 1-3 taken together show that double hinge mechanism 20 of the present invention operates by sequential opening of a first and then a second hinge with both being activated by the same opening force.

Turning now to FIG. 4, a perspective view of hinge mechanism 20 is shown on a stand-alone basis without attachment or assembly with either a door or cabinet housing. A careful examination of hinges 21 and 22 and attachment flanges 24 and 25 show that hinge 20 is in the partially open configuration shown in FIG. 2. An optional feature shown in Figure is reinforcement ring member 26. This reinforcement ring member is molded on the outside of u-shaped body 23 in order to stiffen body 23 except in the region of hinges 21 and 22. It is believed that one advantage of reinforcement ring member 26 is enablement of less resin material within body 23 to achieve the desired amount of strength and stiffness in the body 23.

In sum, an innovative double hinge mechanism has been presented wherein a plurality of hinges operate sequentially to first lift and free a door from its cabinet housing and then to allow the door to swing fully open. In a preferred embodiment, the double hinge mechanism of the present invention is formed of a single piece of semi-rigid material such as certain plastics. Also preferably, the double hinges incorporate springs or comprise spring-like material that aid return of the door to its resting location once the opening forces are removed.

Any number of refinements and embodiments to the above described double hinge mechanism are possible. For instance, different housing and door configurations and thicknesses are possible. Hinge body 23 can vary in shape to conform to the precise dimensions of the door and housing and to redirect opening forces initially to a first hinge and then secondarily to the second hinge. As used herein, the terms “housing,” “enclosure”, “spring”, and “door” are meant in their broadest possible sense and are intended to cover any number of embodiments where two members are connected together by one or more hinges.

It is, therefore, evident that there has been provided in accordance with the present invention a double hinge mechanism that fully satisfies the aims and advantages set forth above. While the invention has been described in conjunction with several embodiments, it is evident that many alternatives, modifications, and variations will be apparent to those skilled in the art. Accordingly, it is intended to embrace all such alternatives, modifications, and variations as fall within the spirit and broad scope of the appended claims.

What is claimed is:

1) An improved hinge assembly with a plurality of hinge elements for mounting a door to an enclosure body, comprising:
(a) a first hinge
(b) a second hinge; and
(c) a hinge body having a first and second edge wherein the first hinge is connected to the hinge body proximate to the first edge and the second hinge is connected to the hinge body proximate to the second edge and wherein a single force operating upon the door sequentially moves the first hinge and then the second hinge.

2) The hinge assembly of claim 1, wherein the hinge body has a nonlinear shape.

3) The hinge assembly of claim 1, wherein the hinges are comprised of semi-rigid material.

4) The hinge assembly of claim 1, wherein the hinges and hinge body are formed from a single piece of molded semi-rigid material.

5) The hinge assembly of claim 4, wherein the hinges and hinge body are formed from a single piece of polypropylene.

6) The hinge assembly of claim 1, wherein the hinges and hinge body are formed from a single piece of extruded semi-rigid material.

7) The hinge assembly of claim 1, wherein the hinges and hinge body are formed from a single piece of molded semi-rigid material.

8) The hinge assembly of claim 1, wherein the hinge assembly is mounted within the interior of the enclosure body.

9) The hinge assembly of claim 1, wherein the second hinge is stronger than the first hinge.

10) The hinge assembly of claim 1, wherein:
(a) the first and second hinges are comprised of the same material and have a hinge region where bending occurs; and
(b) the second hinge is comprised of more material in the hinge region than the first hinge.

11) The hinge assembly of claim 1, wherein the hinge body has a general arcurate shape.

12) The hinge assembly of claim 1, wherein:
(a) the door has an edge proximate to the hinge assembly; and
(b) the hinge assembly has a fully closed position wherein the proximate edge of the door is in contact with the enclosure body when the hinge assembly is in its fully closed position.

13) The hinge assembly of claim 1, wherein:
(a) the first hinge further comprises a first attachment flange;
(b) the second hinge further comprises a second attachment flange;
(c) the hinge assembly has a closed position; and
(d) the first and second flanges are approximately in parallel orientation to each other when the hinge assembly is in its closed position.

14) The hinge assembly of claim 1, wherein the hinge body extends along at least most of an edge of the door.

15) The hinge assembly of claim 1, further comprising a stop mounted on the enclosure body wherein movement of the first hinge is arrested by contact with the stop.

16) The hinge assembly of claim 1, wherein:
(a) the first and the second hinge each has a closed position; and
(b) the hinge assembly has an intermediate position comprising the first hinge moved from its closed position and the second hinge in its closed position.

17) The hinge assembly of claim 1, wherein the hinge body is shaped such that exertion of the single force applies greater initial pressure upon the first hinge than the second hinge.

18) The hinge assembly of claim 1, wherein at least one hinge comprises a spring.

19) The hinge assembly of claim 1, further comprising a reinforcement ring member attached to at least a portion of the hinge body.

20) A process for opening a door covering of an enclosure body wherein the door covering is attached to the enclosure body by a plurality of hinge elements connected by a hinge body, said process comprising:
(a) applying an opening force to the door wherein the force first operates upon a first hinge element;
(b) continuing application of the force until the first hinge element has at least partially opened; and
(c) continuing application of the force until the force operates primarily upon a second hinge element after the first hinge element has at least partially opened.
